(19) United States
(12) Patent Application Publication
(10) Pub. No.: US 2021/0019827 A1
(43) Pub. Date: Jan. 21, 2021

(54) METHOD AND SYSTEM FOR DRIVING CIRCUIT BREAKER OF CRYPTOCURRENCY EXCHANGE

(71) Applicant: LINE CORPORATION, Tokyo (JP)

(72) Inventors: Jaeman Kim, Seongnam-si (KR); Miyoung Jang, Seongnam-si (KR); Nara Hwang, Seongnam-si (KR); Hyun Dong Lee, Seongnam-si (KR); Dong Young Heo, Seongnam-si (KR); Byung Jun Hwang, Seongnam-si (KR); Byeong Guk Gim, Seongnam-si (KR)

(73) Assignee: LINE CORPORATION, Tokyo (JP)

(21) Appl. No.: 16/930,722

(22) Filed: Jul. 16, 2020

(30) Foreign Application Priority Data
Jul. 16, 2019 (KR) 10-2019-0085760

(51) Int. Cl. G06Q 40/04; G06Q 30/02; G06Q 20/36

(52) U.S. Cl. CPC G06Q 40/04; G06Q 20/3678; G06Q 30/0206

(57) ABSTRACT

A cryptocurrency trading management method executed by a computer system is provided. The method may include: collecting trading information associated with a cryptocurrency for each cryptocurrency exchange with respect to a plurality of cryptocurrency exchanges; determining a market price of the cryptocurrency in a cryptocurrency market comprising the plurality of cryptocurrency exchanges, based on the trading information; comparing a trading price of the cryptocurrency on a first cryptocurrency exchange of the plurality of cryptocurrency exchanges with the market price; and triggering a circuit breaker for the cryptocurrency based on a result of the comparing the trading price with the market price.

### CROSS-REFERENCE TO RELATED APPLICATION

This application claims priority to Korean Patent Application No. 10-2019-0085760, filed Jul. 16, 2019 in the Korean Intellectual Property Office, the disclosure of which is incorporated herein by reference in its entirety.

### BACKGROUND

### 1. Field

Apparatuses and methods consistent with example embodiments relate to technology for managing a cryptocurrency trading.

### 2. Description of Related Art

Currently, with the advent of encryption technology, interest in cryptocurrency based on encryption technology continues to grow.

A representative example of a cryptocurrency includes Bitcoin (BTC). In addition thereto, Ethereum (ETH), Litecoin (LTC), and dash are leading the cryptocurrency market.

Unlike traditional currencies issued by governments or central banks, such cryptocurrencies are priced according to regulations set by original creators and are being distributed based on blockchain technology.

However, a cryptocurrency exchange is not equipped with a safeguard to protect assets of a user for a difference in market prices from other cryptocurrency exchanges.

A cryptocurrency exchange is not in a central structure for managing a quote price. That is, each cryptocurrency exchange may manipulate the quote price or a market price, or may operate the same separately from a market price formed in a corresponding cryptocurrency exchange market. That is, since the quote price or a market price is formed for each cryptocurrency exchange, a price may soar or plunge only on a specific cryptocurrency exchange.

Due to such market features, it is difficult to prepare for or prevent damage to users making trading on a cryptocurrency exchange. Also, an arbitrage trading, such as securing the quantity on a single cryptocurrency exchange and selling the secured quantity on other exchanges, may occur. As a result, users using the corresponding cryptocurrency exchange may have hug financial damage.

### SUMMARY

Example embodiments address at least the above problems and/or disadvantages and other disadvantages not described above. Also, the example embodiments are not required to overcome the disadvantages described above, and may not overcome any of the problems described above.

One or more example embodiments provide a method and an apparatus for monitoring market prices of a plurality of other cryptocurrency exchanges and detecting a sudden change in a market price of a cryptocurrency exchange.

Further, example embodiments may provide a method and a system for monitoring a market price of a cryptocurrency and triggering a circuit breaker based on a market trend.

According to an aspect of an example embodiment, there is provided a cryptocurrency trading management method executed by a computer system, the method including: collecting trading information associated with a cryptocurrency for each cryptocurrency exchange with respect to a plurality of cryptocurrency exchanges; determining a market price of the cryptocurrency in a cryptocurrency market comprising the plurality of cryptocurrency exchanges, based on the trading information; comparing a trading price of the cryptocurrency on a first cryptocurrency exchange of the plurality of cryptocurrency exchanges with the market price; and triggering a circuit breaker for the cryptocurrency based on a result of the comparing the trading price with the market price.

The determining the market price may include determining the market price based on price information of the cryptocurrency on the plurality of cryptocurrency exchanges.

The determining the market price may include: selecting one or more cryptocurrency exchanges from the plurality of cryptocurrency exchanges; and determining the market price based on price information of the cryptocurrency on the selected one or more cryptocurrency exchanges.

The determining the market price may include: determining an exchange confidence score based on the trading information for each cryptocurrency exchange; selecting one or more cryptocurrency exchanges from the plurality of cryptocurrency exchanges based on the exchange confidence score; and determining the market price based on price information of the cryptocurrency on the selected one or more cryptocurrency exchanges.

The determining the exchange confidence score may include determining the exchange confidence score based on at least two factors among a number of users of each cryptocurrency exchange, a rate of a volume of the cryptocurrency on the first cryptocurrency exchange divided by an entire cryptocurrency volume of the cryptocurrency in the cryptocurrency market, a number of hacking occurrences, a number of failure occurrences, a license acquisition status, and a cryptocurrency trading service providing period of each cryptocurrency exchange.

The selecting the one or more cryptocurrency exchanges may include selecting the one or more cryptocurrency exchanges having a highest confidence score or selecting the one or more cryptocurrency exchanges having the exchange confidence score that is greater than or equal to a predetermined score.

The determining the market price may include determining an average price, a minimum price, and a maximum price of the cryptocurrency in the cryptocurrency market based on the price information of the cryptocurrency on the selected one or more cryptocurrency exchanges.

The triggering the circuit breaker may include triggering the circuit breaker based on the trading price being out of a predetermined range of the market price.

The determining the market price may include determining the market price at regular time intervals, and the triggering the circuit breaker may include triggering the circuit breaker based on the trading price for a first time duration being out of the predetermined range of the market price determined for a second time duration that is previous to the first time duration.

The triggering the circuit breaker may include sequentially triggering a plurality of circuit breaker modes having different triggering criterion based on a number of times that the trading price is out of the predetermined range of the market price being greater than a predetermined number of times.

The triggering the circuit breaker may include: selecting a circuit breaker mode from a plurality of circuit breaker modes having different triggering criterion, based on a difference between the trading price of the cryptocurrency on the first cryptocurrency exchange and the market price; and triggering the circuit breaker based on the selected circuit breaker mode.

The cryptocurrency on the first cryptocurrency exchange may be traded through a plurality of market cryptocurrencies, and the trading information may include a single market cryptocurrency among the plurality of market cryptocurrencies that is paired with the cryptocurrency.

The cryptocurrency trading management method may be executed by the computer system associated with the first cryptocurrency exchange, and the collecting the trading information may include collecting the trading information with respect to the plurality of cryptocurrency exchanges.

According to an aspect of another example embodiment, there is provided a non-transitory computer-readable record medium storing instructions that, when executed by the computer system, cause the computer system to perform the cryptocurrency trading management method.

According to an aspect of another example embodiment, there is provided a computer system including: at least one memory configured to store computer-readable instructions; and at least one processor configured to execute the computer-readable instructions to: collect trading information associated with a cryptocurrency for each cryptocurrency exchange with respect to a plurality of cryptocurrency exchanges; determine a market price of the cryptocurrency in a cryptocurrency market comprising the plurality of cryptocurrency exchanges, based on the trading information; compare a trading price of the cryptocurrency on a first cryptocurrency exchange of the plurality of cryptocurrency exchanges with the market price; and trigger a circuit breaker for the cryptocurrency based on a result of the comparing the trading price with the market price.

The at least one processor may be further configured to execute the computer-readable instructions to: determine an exchange confidence score based on the trading information for each cryptocurrency exchange; select one or more cryptocurrency exchanges from the plurality of cryptocurrency exchanges based on the exchange confidence score; and determine the market price based on price information of the cryptocurrency on the selected one or more cryptocurrency exchanges.

The at least one processor may be further configured to execute the computer-readable instructions to: select one or more cryptocurrency exchanges from among the plurality of cryptocurrency exchanges; and determine the market price based on at least one of an average price, a minimum price, and a maximum price of the cryptocurrency in the cryptocurrency market, based on price information of the cryptocurrency on the selected one or more cryptocurrency exchanges.

The at least one processor may be further configured to execute the computer-readable instructions to: trigger the circuit breaker based on the trading price being out of a predetermined range of the market price.

The at least one processor may be further configured to execute the computer-readable instructions to sequentially trigger a plurality of circuit breaker modes having different triggering criterion, based on a number of times that the trading price is out of the predetermined range of the market price being greater than a predetermined number of times.

The at least one processor may be further configured to execute the computer-readable instructions to: select a single circuit breaker mode from among a plurality of circuit breaker modes having different triggering criterion, based on a difference between the trading price of the cryptocurrency on the first cryptocurrency exchange and the market price; and trigger the circuit breaker based on the selected circuit breaker mode.

### BRIEF DESCRIPTION OF THE FIGURES

The above and/or other aspects will be more apparent by describing certain example embodiments, with reference to the accompanying drawings, in which:

FIG. 1 illustrates an example of a monitoring service environment for managing a cryptocurrency trading according to at least one example embodiment;

FIG. 2 is a block diagram illustrating an example of an internal configuration of a computer system according to at least one example embodiment;

FIG. 3 is a diagram illustrating an example of components includable in a processor of a computer system according to at least one example embodiment;

FIG. 4 is a flowchart illustrating an example of a cryptocurrency trading management method performed by a computer system according to at least one example embodiment;

FIG. 5 illustrates an example of a trading information table for each cryptocurrency exchange according to at least one example embodiment;

FIG. 6 is a flowchart illustrating an example of a method of calculating a market price of a cryptocurrency according to at least one example embodiment.

FIG. 7 illustrates an example of a method of calculating an exchange confidence score according to at least one example embodiment; and

FIG. 8 illustrates an example of a market price information table for each cryptocurrency according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments are described with reference to the accompanying drawings.

The example embodiments relate to technology for managing a cryptocurrency trading.

The example embodiments including the disclosures of the present specification may monitor a market price of a cryptocurrency traded on a cryptocurrency exchange, may trigger a circuit breaker based on a market trend, and accordingly, may function as a safeguard in a cryptocurrency market and thereby minimize financial damage to users.

Hereinafter, example embodiments of a method and system for triggering a circuit breaker on a cryptocurrency exchange are described.

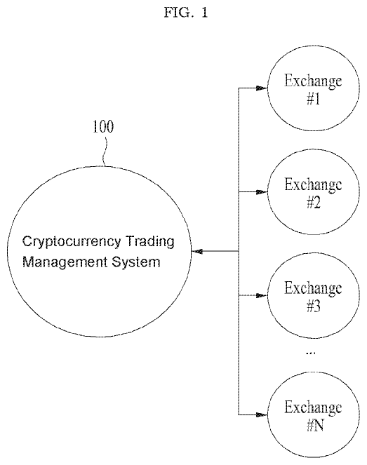

FIG. 1 illustrates an example of a monitoring service environment for managing a cryptocurrency trading according to at least one example embodiment.

Referring to FIG. 1, a cryptocurrency trading management system 100 may function as a service platform for monitoring cryptocurrency exchanges (e.g., Exchange #1, Exchange #2, Exchange #3, . . . , Exchange #N).

The cryptocurrency trading management system 100 simultaneously monitors trading prices of a cryptocurrency being traded on each of a plurality of cryptocurrency exchanges, and provides a function of triggering a circuit breaker based on a difference in the trading prices of the plurality of cryptocurrency exchanges. The trading price of the same cryptocurrency (e.g., Bitcoin) may vary among the different cryptocurrency exchanges (e.g., Exchange #1, Exchange #2, Exchange #3, . . . , Exchange #N).

For example, the cryptocurrency trading management system 100 may be configured in a single system form integrated with a server system of a cryptocurrency exchange side and may provide a monitoring service for a corresponding cryptocurrency exchange. Here, the cryptocurrency trading management system 100 may be configured in a form of a program that independently operates, or may be configured in an in-app form of a specific application to be operable on the specific application.

As another example, the cryptocurrency trading management system 100 may be configured in a form of a central server to provide a monitoring service for a plurality of cryptocurrency exchanges through interaction with server systems on the side of the plurality of cryptocurrency exchanges.

The cryptocurrency trading management system 100 may function as a safeguard capable of protecting assets of users against a sudden rise and fall of a cryptocurrency in a cryptocurrency market.

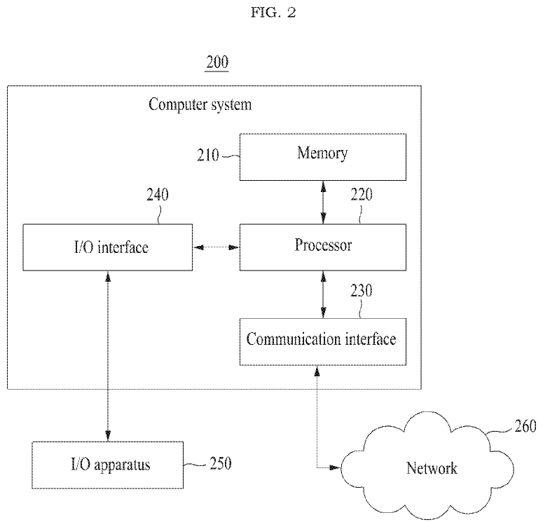

FIG. 2 is a diagram illustrating an example of a computer system according to at least one example embodiment. For example, a cryptocurrency trading management system 100 according to example embodiments may be implemented using a computer system 200 of FIG. 2.

Referring to FIG. 2, the computer system 200 may include a memory 210, a processor 220, a communication interface 230, and an input/output (I/O) interface 240 as components for implementing a cryptocurrency trading management method according to example embodiments.

The memory 210 may include a permanent mass storage device, such as random access (RAM), read only memory (ROM), and a disc drive, as a non-transitory computer-readable storage medium. Here, the permanent mass storage device, such as ROM and disc drive, may be included in the computer system 200 as a separate permanent storage device different from the memory 210. Also, an operating system (OS) and at least one program code may be stored in the memory 210. Such software components may be loaded from another non-transitory computer-readable storage medium to the memory 210. The other non-transitory computer-readable storage medium may include a non-transitory computer-readable storage medium, for example, a floppy drive, a disk, a tape, a DVD/CD-ROM drive, a memory card, etc. According to other example embodiments, software components may be loaded to the memory 210 through the communication interface 230, instead of, or in addition to, the non-transitory computer-readable storage medium. For example, the software components may be loaded to the memory 210 of the computer system 200 based on a computer program installed by files received over a network 260.

The processor 220 may be configured to process computer-readable instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to a program code stored in a storage device, such as the memory 220.

The communication interface 230 may provide a function for communication between the computer system 200 and another apparatus over the network 260. For example, the processor 220 of the computer system 200 may transfer data, a file, a request or an instruction created based on the program code stored in the storage device, such as the memory 220, to other apparatuses over the network 260 under control of the communication interface 230. Inversely, a signal, an instruction, data, a file, etc., from another apparatus may be received at the computer system 200 through the communication interface 230 of the computer system 200. For example, a signal, an instruction, data, etc., received through the communication interface 230 may be transferred to the processor 220 or the memory 210, and a file, etc., may be stored in a storage medium, for example, the permanent storage device, further includable in the computer system 200.

The communication scheme is not limited and may include a near field wired/wireless communication scheme between devices as well as a communication scheme using a communication network (e.g., a mobile communication network, wired Internet, wireless Internet, and a broadcasting network) includable in the network 260. For example, the network 260 may include at least one of network topologies that includes a personal area network (PAN), a local area network (LAN), a campus area network (CAN), a metropolitan area network (MAN), a wide area network (WAN), a broadband network (BBN), and Internet. Also, the network 260 may include at least one of network topologies that include a bus network, a star network, a ring network, a mesh network, a star-bus network, a tree or hierarchical network, and the like. However, they are provided as examples only.

The I/O interface 240 may be a device used for interface with an I/O apparatus 250, such as an input device and/or an output device. Examples of the input device may include a microphone, a keyboard, and a mouse, and examples of the output device may include a display device and a speaker. As another example, the I/O interface 240 may be a device for interface with an apparatus in which an input function and an output function are integrated into a single function, such as a touchscreen. The I/O apparatus 250 may be configured as a single apparatus with the computer system 200.

According to other example embodiments, the computer system 200 may include a number of components greater than or less than a number of components shown in FIG. 2. For example, the computer system 200 may include at least a portion of the I/O apparatus 250, or may further include other components, for example, a transceiver, a database (DB), and the like.

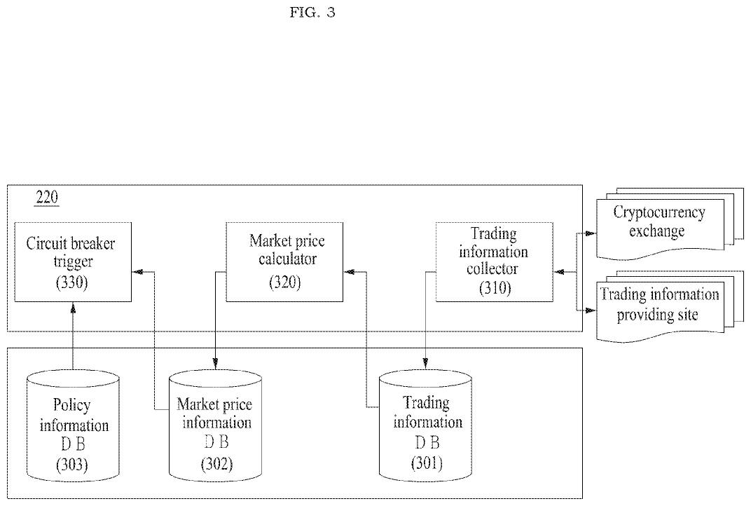

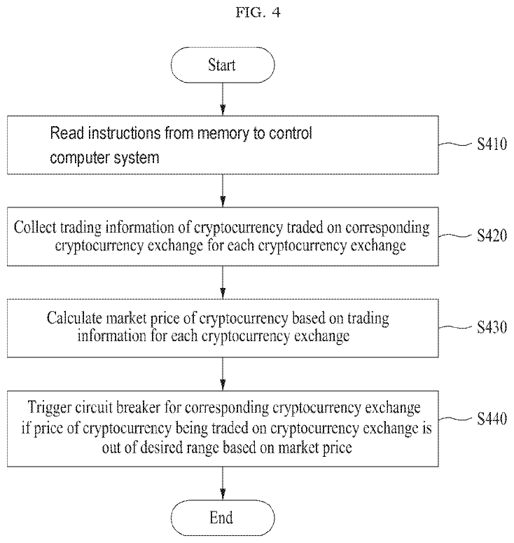

FIG. 3 is a diagram illustrating an example of components includable in a processor of a computer system and a database according to at least one example embodiment, and FIG. 4 is a flowchart illustrating an example of a cryptocurrency trading management method performed by a computer system according to at least one example embodiment.

Referring to FIG. 3, the processor 220 may include a trading information collector 310, a market price calculator 320, and a circuit breaker trigger 330 as components to execute the cryptocurrency trading management method. Depending on example embodiments, the components of the processor 220 may be selectively included in or excluded from the processor 220. Also, depending on example embodiments, the components of the processor 220 may be separated or merged for representation of functions of the processor 220.

The processor 220 may store and maintain relevant information through a database to provide a monitoring service for managing a cryptocurrency trading. Referring to FIG. 3, the database may include a trading information database (DB) 301, a market price information DB 302, and a policy information DB 303, and may be included in the computer system 200 as a storage device separate from the memory 210, or may be configured as a separate system interactable with the computer system 200.

The processor 220 and the components of the processor 220 may control the computer system 200 to perform operations S410 to S440 of the cryptocurrency trading management method as shown in FIG. 4. For example, the processor 220 and the components of the processor 220 may be configured to execute an instruction according to a code of at least one program and a code of an OS included in the memory 210. Here, at least one program code may correspond to a code of a program configured to process the cryptocurrency trading management method.

The components of the processor 220 may be representations of different functions performed by the processor 220 in response to a control instruction provided from at least one program code. For example, the trading information collector 310 may be used as a functional representation that operates to control the computer system 200 such that the processor 220 may collect trading information of each cryptocurrency exchange.

The following cryptocurrency trading management method may not be performed in the illustrated order, and a portion of operations may be omitted or an additional process may be further included.

Referring to FIG. 4, in operation S410, the processor 220 may read instructions from the memory 210 to control the computer system 200. In particular, the read instructions may cause the processor 220 to perform operations S420 to S440.

In operation S420, the trading information collector 310 may collect trading information of a cryptocurrency traded on a corresponding cryptocurrency exchange for each cryptocurrency exchange. Here, the trading information may include volume and price information of the cryptocurrency traded during a unit period (e.g., 30 minutes) on the corresponding cryptocurrency exchange. The price information refers to a price of the cryptocurrency being traded on the cryptocurrency exchange and may represent the average price in response to a change in the price of the cryptocurrency traded during the unit period. The cryptocurrency trading management method may be performed by the computer system 200 associated with a specific cryptocurrency exchange. Here, the trading information collector 310 may collect cryptocurrency trading information with respect to a plurality of cryptocurrency exchanges different from the specific cryptocurrency exchange. For example, the trading information collector 310 may collect cryptocurrency trading information from a corresponding cryptocurrency exchange through direct interaction with each cryptocurrency exchange. As another example, the trading information collector 310 may provide cryptocurrency trading information for each cryptocurrency exchange through interaction with a trading information providing site that provides volume and price information of each cryptocurrency exchange.

The trading information collector 310 may store and manage trading information for each cryptocurrency exchange collected from each corresponding cryptocurrency exchange or the trading information providing site in the trading information DB 301.

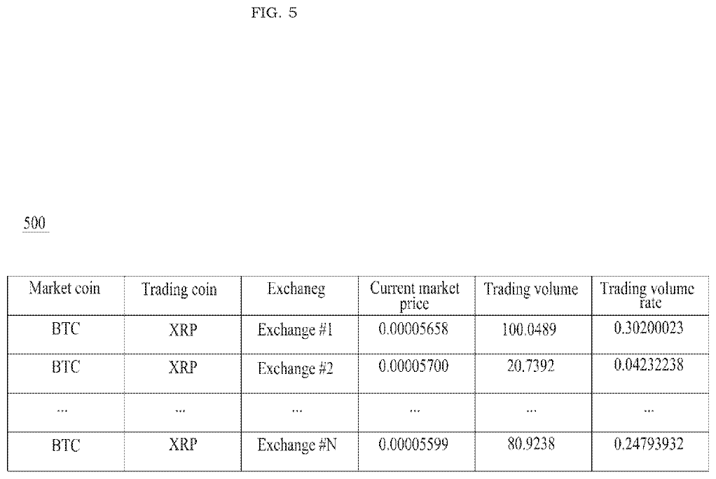

FIG. 5 illustrates an example of a trading information table 500 stored in the trading information DB 301 according to at least one example embodiment.

Referring to FIG. 5, the trading information table 500 may include a price of a cryptocurrency currently being traded (e.g., a current trading price on each cryptocurrency exchange), a volume (e.g., a trading volume that represents a total amount of buy and sell orders that have occurred during a predetermined period of time), and a trading rate (e.g., a trading volume rate) to the entire cryptocurrency volume for each cryptocurrency exchange (e.g., Exchange #1, Exchange #2, Exchange #3, . . . , Exchange #N) that is a collection target. For example, Exchange #1, Exchange #2, and Exchange #3 may refer to HCoin exchange, Coinsbit exchange, and BitForex change that allow users to transact bitcoins.

In addition, a number of hacking accidents, a number of failure occurrences, and a cryptocurrency trading service providing period of each cryptocurrency exchange may be included in trading information and thereby managed through the trading information table 500.

The trading information collector 310 may generate the trading information table 500 by collecting trading information associated with a corresponding cryptocurrency for each cryptocurrency exchange with respect to a plurality of cryptocurrency exchanges capable of trading a cryptocurrency for each type of cryptocurrency, for example, Bitcoin (BTC), Ethereum (ETH), Litecoin (LTC), dash, and the like. A specific cryptocurrency (trading cryptocurrency; trading coin) that is traded on a specific cryptocurrency exchange may be traded through a plurality of market cryptocurrencies (market coins). Trading information associated with a cryptocurrency (also, referred to as cryptocurrency trading information) may be collected for a pair of a single market cryptocurrency among the plurality of market cryptocurrencies and a specific cryptocurrency.

Referring again to FIG. 4, in operation S430, the market price calculator 320 may calculate a market price of a cryptocurrency in the entire cryptocurrency market (including Exchange #1, Exchange #2, Exchange #3, . . . and Exchange #N shown in FIG. 1) based on trading information for each cryptocurrency exchange. For example, the market price calculator 320 may average prices of all of the cryptocurrency exchanges corresponding to the collection target and may determine an average cryptocurrency price as a market price in the entire cryptocurrency market. As another example, the market price calculator 320 may select a reliable cryptocurrency exchange from the cryptocurrency market and then may average only price of the selected cryptocurrency exchange and determine the average price information as a market price in the entire cryptocurrency market. As another example, the market price calculator 320 may calculate a weight for each cryptocurrency exchange based on trading information, for example, a number of hacking accidents, a number of failure occurrences, a cryptocurrency trading service providing period, and the like, for each cryptocurrency exchange stored in the trading information table 500, and may determine a price in the entire cryptocurrency market based on price information and the weight of each cryptocurrency exchange.

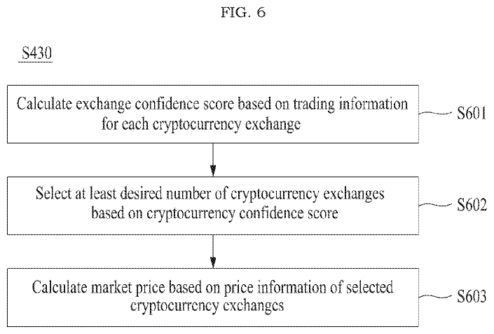

FIG. 6 is a flowchart illustrating an example of a method of calculating a market price of a cryptocurrency according to at least one example embodiment.

Referring to FIG. 6, in operation S601, the market price calculator 320 may calculate an exchange confidence score based on trading information for each cryptocurrency exchange. For example, the market price calculator 320 may calculate an exchange confidence score based on a recognition factor and a confidence factor for a corresponding cryptocurrency exchange. Here, the recognition factor may include a volume rate on a corresponding cryptocurrency exchange in the entire cryptocurrency market (e.g., a volume rate representing a trading volume of the corresponding cryptocurrency exchange divided by a total trading volume of cryptocurrency of a plurality of cryptocurrency exchanges), a number of subscribe users, and the like. The confidence factor may include a hacking occurrence status, a failure occurrence status, a license acquisition status, a cryptocurrency trading service providing period, and the like. The market price calculator 320 may calculate the exchange confidence score by summing at least one score of the recognition factor and the confidence factor. Here, a different weight may apply to each of the recognition factor and the confidence factor.

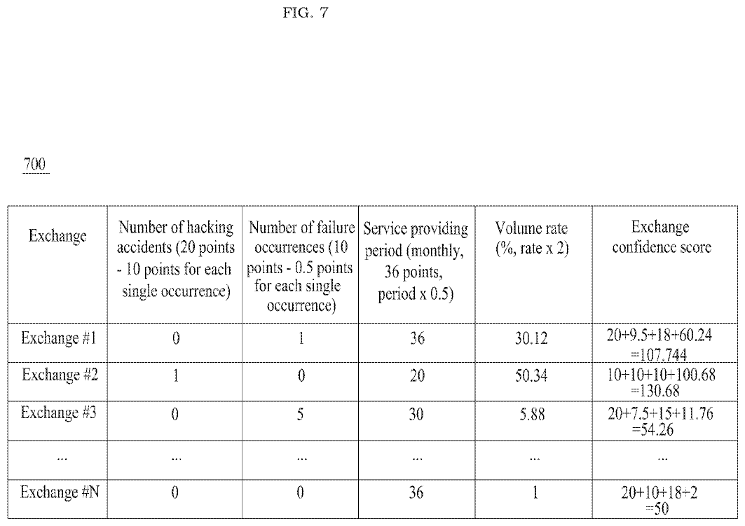

FIG. 7 illustrates an example of a method of calculating an exchange confidence score according to at least one example embodiment. FIG. 7 illustrates an exchange confidence score table 700 for each cryptocurrency exchange.

For example, the market price calculator 320 may calculate an exchange confidence score based on a number of hacking accidents, a number of failure occurrences, a cryptocurrency trading service providing period, and a volume rate. For example, the market price calculator 320 may determine a score for the number of hacking accidents by subtracting 10 points from 20 points for each single occurrence, and may determine a score for the number of failure occurrences by subtracting 0.5 points from 10 points for each single occurrence. The market price calculator 320 may calculate a score for the cryptocurrency trading service providing period based on a monthly unit by multiplying a corresponding period (e.g., a corresponding period having a value in a range from 0 to 36 points) by a weight of 0.5. The market price calculator 320 may determine a score for a volume rate (e.g., a percentage volume rate score) by multiplying the trading volume of the entire cryptocurrency exchanges by a predetermined weight (e.g., a weight of 2 which represents a percentage of the volume of a specific cryptocurrency exchange). The market price calculator 320 may calculate an exchange confidence score by summing all of the score for the number of hacking accidents, the score for the number of failure occurrences, the score for the cryptocurrency trading service providing period, and the score for the volume rate.

The aforementioned exchange confidence score calculation method is provided as an example only. Any calculation methods capable of applying at least one of a recognition factor and a confidence factor may apply.

Referring again to FIG. 6, in operation S602, the market price calculator 320 may select at least two cryptocurrency exchanges from among cryptocurrency exchanges included in a trading information collection target based on the exchange confidence score as a reliable cryptocurrency exchange in the cryptocurrency market. For example, the market price calculator 320 may select a predetermined number of, for example, 10 cryptocurrency exchanges having a top exchange confidence score based on the exchange confidence score. As another example, the market price calculator 320 may select a cryptocurrency exchange having an exchange confidence score greater than or equal to a desired level. That is, the market price calculator 320 may exclude a cryptocurrency exchange having an exchange confidence score less than the desired level from a market price calculation process to not apply to a market price of the cryptocurrency market. As another example, the market price calculator 320 may select a portion of or all of cryptocurrency exchanges included in the trading information collection target, and may calculate a weight for each cryptocurrency exchange based on an exchange confidence score of each selected cryptocurrency exchange.

In operation S603, the market price calculator 320 may calculate a market price of the cryptocurrency based on price information of the cryptocurrency exchanges selected in operation S602. Here, the market price calculator 320 may select a reliable cryptocurrency exchange, may average price of the selected cryptocurrency exchange, and may determine the average price as the market price in the cryptocurrency market. As another example, the market price calculator 320 may calculate the market price in the cryptocurrency market based on a weight and price information of the selected cryptocurrency exchange.

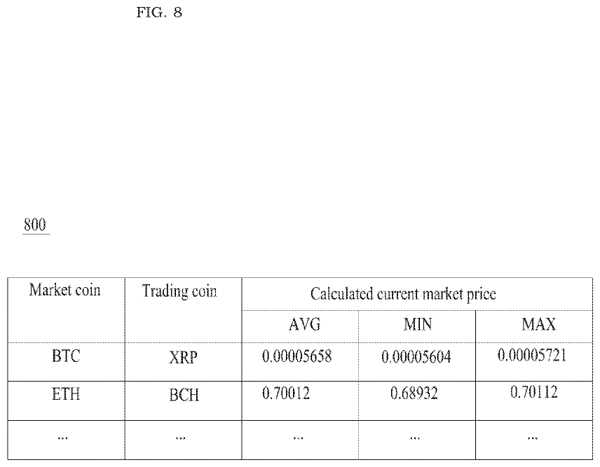

FIG. 8 illustrates an example of a market price information table 800 for each cryptocurrency according to at least one example embodiment.

Referring to FIG. 8, the market price calculator 320 may calculate an average price (AVG), a minimum price (MIN), and a maximum price (MAX) as market price information of the cryptocurrency market, based on a price of a cryptocurrency being traded on each cryptocurrency exchange with respect to cryptocurrency exchanges selected based on an exchange confidence score.

The market price calculator 320 may generate the market price information table 800 by calculating market price information for each pair of a market cryptocurrency (market coin) and a trading cryptocurrency (trading coin), for example, BTC-XRP, ETH-BCH, etc., or for each cryptocurrency type, for example, BTC, ETH, LTC, dash, etc.

The market price calculator 320 may calculate market price information for a cryptocurrency at regular time intervals by using a set time as a period and may generate market price information for each time duration.

The market price calculator 320 may maintain and manage the exchange confidence score table 700 for each cryptocurrency exchange and the cryptocurrency market price information table 800 generated through the aforementioned operations S601 to S603, through the market price information DB 302.

Therefore, the market price calculator 320 may select a predetermined (or, alternatively, desired) number of reliable cryptocurrency exchanges in the cryptocurrency market by using the exchange confidence score as a weight for a corresponding cryptocurrency exchange and may calculate a market price of the cryptocurrency market based on price information of the selected cryptocurrency exchange.

Referring again to FIG. 4, in operation S440, the circuit breaker trigger 330 may trigger a circuit breaker for a corresponding cryptocurrency exchange (e.g., a first cryptocurrency exchange of a plurality of cryptocurrency exchanges) if a trading price of a cryptocurrency being traded on the cryptocurrency exchange (e.g., the first cryptocurrency exchange) is out of a predetermined (or, alternatively, desired) range based on the market price of the cryptocurrency market (including the plurality of cryptocurrency exchanges). The circuit breaker trigger 330 may compare the trading price of the cryptocurrency on the cryptocurrency exchange (e.g., the first cryptocurrency exchange) with the market price of the cryptocurrency market (including the plurality of cryptocurrency exchanges), and may determine whether to trigger a circuit breaker based on a result of the comparison. The circuit breaker trigger 330 may obtain, from the market price calculator 320, information of the market price at the time at which the cryptocurrency is traded on the first cryptocurrency exchange. For example, when the computer system 200 receives a trading request, which contains information of a cryptocurrency C₁ (e.g., Bitcoin) and a trading amount (e.g., $100), at time T₁ (e.g., Jun. 1, 2019 at 10:30 AM) from a user, the circuit breaker trigger 330 may request the market price calculator 320 to provide information of a market price Pₘ of the cryptocurrency C₁ at time T₁. The circuit breaker trigger 330 may receive information of the market price Pₘ of the cryptocurrency C₁ or an average market price P_{m′} of the cryptocurrency C₁ during a time interval including time T₁. Here, the predetermined (or, alternatively, desired) range that is a criterion to trigger the circuit breaker may be set based on a minimum price and a maximum price that are calculated based on market price information of the cryptocurrency market, for example, may be set as the range that includes the minimum price and the maximum price. For example, the circuit breaker trigger 330 may trigger a circuit breaker mode if a cryptocurrency price on a specific cryptocurrency exchange plunges beyond the predetermined (or, alternatively, desired) range of the market price.

The circuit breaker trigger 330 may monitor a price of a cryptocurrency being traded on a cryptocurrency exchange and, if there is a difference in trading prices by a predetermined (or, alternatively, desired) amount based on the cryptocurrency market price information table 800 stored in the market price information DB 302, may trigger a circuit breaker for the corresponding cryptocurrency exchange.

If a cryptocurrency price on a cryptocurrency exchange collected for a specific time duration based on cryptocurrency market price information calculated at regular time intervals is out of a predetermined (or, alternatively, desired) range based on a market price calculated for a previous time duration of the specific time duration (fluctuations), the circuit breaker trigger 330 may trigger a circuit breaker on a corresponding cryptocurrency exchange.

The computer system 200 may enter the circuit breaker mode when predetermined one or more criteria are satisfied. The predetermined one or more criteria may be stored in the policy information DB 303 and retrieved by the processor 220 of the computer system 200.

The predetermined one or more criteria for triggering the circuit breaker may be individually and/or differently set for each cryptocurrency exchange, or may be set to have the same criteria for a plurality of cryptocurrency exchanges.

The circuit breaker mode may be set using various policies, such as, for example, a first mode for providing a single quote, a second mode for delaying a trade settlement speed of a cryptocurrency, and a third mode for temporarily halting a trading of a cryptocurrency.

For example, if a trading price of a cryptocurrency is out of a market price range, the circuit breaker trigger 330 may trigger a circuit breaker in a single preset mode among the first mode, the second mode, and the third mode.

As another example, if a cryptocurrency price repeatedly becomes out of a market price range during a unit period (e.g., if the number of times that the trading price of the cryptocurrency falls out of the market price range is greater than a predetermined number of times during the unit period), the circuit breaker trigger 330 may sequentially trigger the first mode, the second mode, and the third mode. For example, the circuit breaker trigger 330 may trigger the first mode in response to a first detection of a situation in which the cryptocurrency price is out of the market price range, and may sequentially trigger the second mode and the third mode in response to a subsequent detection of the same situation.

As another example, the circuit breaker trigger 330 may select a single mode from among the first mode, the second mode, and the third mode based on how much the cryptocurrency price is out of the market price range, and may trigger a circuit breaker. For example, the circuit breaker trigger 330 may trigger the first mode if a difference in trading prices is less than or equal to a preset first level, may trigger the second mode if the difference is less than or equal to a second level greater than the first level, and may trigger the third mode if the difference exceeds the second level.

Accordingly, if a price of a cryptocurrency being traded on a corresponding cryptocurrency exchange is out of a predetermined (or, alternatively, desired) range of a market price of the entire cryptocurrency market, that is, if the cryptocurrency price is different by a predetermined (or, alternatively, desired) level from a price of the cryptocurrency being traded on another cryptocurrency exchange determined to be reliable, the circuit breaker trigger 330 may trigger a circuit breaker mode for the corresponding cryptocurrency and thereby provide a stable service.

The apparatuses described herein may be implemented using hardware components, software components, and/or a combination thereof. For example, a processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the example embodiments may be recorded in non-transitory computer-readable storage media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable storage media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A cryptocurrency trading management method executed by a computer system, the method comprising:
collecting trading information associated with a cryptocurrency for each cryptocurrency exchange with respect to a plurality of cryptocurrency exchanges;
determining a market price of the cryptocurrency in a cryptocurrency market comprising the plurality of cryptocurrency exchanges, based on the trading information;
comparing a trading price of the cryptocurrency on a first cryptocurrency exchange of the plurality of cryptocurrency exchanges with the market price; and
triggering a circuit breaker for the cryptocurrency based on a result of the comparing the trading price with the market price.

2. The cryptocurrency trading management method of claim 1, wherein the determining the market price comprises determining the market price based on price information of the cryptocurrency on the plurality of cryptocurrency exchanges.

3. The cryptocurrency trading management method of claim 1, wherein the determining the market price comprises:
selecting one or more cryptocurrency exchanges from the plurality of cryptocurrency exchanges; and
determining the market price based on price information of the cryptocurrency on the selected one or more cryptocurrency exchanges.

4. The cryptocurrency trading management method of claim 1, wherein the determining the market price comprises:
determining an exchange confidence score based on the trading information for each cryptocurrency exchange;
selecting one or more cryptocurrency exchanges from the plurality of cryptocurrency exchanges based on the exchange confidence score; and
determining the market price based on price information of the cryptocurrency on the selected one or more cryptocurrency exchanges.

5. The cryptocurrency trading management method of claim 4, wherein the determining the exchange confidence score comprises determining the exchange confidence score based on at least two factors among a number of users of each cryptocurrency exchange, a rate of a volume of the cryptocurrency on the first cryptocurrency exchange divided by an entire cryptocurrency volume of the cryptocurrency in the cryptocurrency market, a number of hacking occurrences, a number of failure occurrences, a license acquisition status, and a cryptocurrency trading service providing period of each cryptocurrency exchange.

6. The cryptocurrency trading management method of claim 4, wherein the selecting the one or more cryptocurrency exchanges comprises selecting the one or more cryptocurrency exchanges having a highest confidence score or selecting the one or more cryptocurrency exchanges having the exchange confidence score that is greater than or equal to a predetermined score.

7. The cryptocurrency trading management method of claim 3, wherein the determining the market price comprises determining an average price, a minimum price, and a maximum price of the cryptocurrency in the cryptocurrency market based on the price information of the cryptocurrency on the selected one or more cryptocurrency exchanges.

8. The cryptocurrency trading management method of claim 1, wherein the triggering the circuit breaker comprises triggering the circuit breaker based on the trading price being out of a predetermined range of the market price.

9. The cryptocurrency trading management method of claim 8, wherein the determining the market price comprises determining the market price at regular time intervals, and
the triggering the circuit breaker comprises triggering the circuit breaker based on the trading price for a first time duration being out of the predetermined range of the market price determined for a second time duration that is previous to the first time duration.

10. The cryptocurrency trading management method of claim 8, wherein the triggering the circuit breaker comprises sequentially triggering a plurality of circuit breaker modes having different triggering criterion based on a number of times that the trading price is out of the predetermined range of the market price being greater than a predetermined number of times.

11. The cryptocurrency trading management method of claim 8, wherein the triggering the circuit breaker comprises:
selecting a circuit breaker mode from a plurality of circuit breaker modes having different triggering criterion, based on a difference between the trading price of the cryptocurrency on the first cryptocurrency exchange and the market price; and
triggering the circuit breaker based on the selected circuit breaker mode.

12. The cryptocurrency trading management method of claim 1, wherein the cryptocurrency on the first cryptocurrency exchange is traded through a plurality of market cryptocurrencies, and
the trading information comprises a single market cryptocurrency among the plurality of market cryptocurrencies that is paired with the cryptocurrency.

13. The cryptocurrency trading management method of claim 1, wherein the cryptocurrency trading management method is executed by the computer system associated with the first cryptocurrency exchange, and
the collecting the trading information comprises collecting the trading information with respect to the plurality of cryptocurrency exchanges.

14. A non-transitory computer-readable record medium storing instructions that, when executed by the computer system, cause the computer system to perform the cryptocurrency trading management method of claim 1.

15. A computer system comprising:
at least one memory configured to store computer-readable instructions; and
at least one processor configured to execute the computer-readable instructions to:
collect trading information associated with a cryptocurrency for each cryptocurrency exchange with respect to a plurality of cryptocurrency exchanges,
determine a market price of the cryptocurrency in a cryptocurrency market comprising the plurality of cryptocurrency exchanges, based on the trading information,
compare a trading price of the cryptocurrency on a first cryptocurrency exchange of the plurality of cryptocurrency exchanges with the market price, and
trigger a circuit breaker for the cryptocurrency based on a result of the comparison of the trading price with the market price.

16. The computer system of claim 15, wherein the at least one processor is further configured to execute the computer-readable instructions to:
determine an exchange confidence score based on the trading information for each cryptocurrency exchange,
select one or more cryptocurrency exchanges from the plurality of cryptocurrency exchanges based on the exchange confidence score, and
determine the market price based on price information of the cryptocurrency on the selected one or more cryptocurrency exchanges.

17. The computer system of claim 15, wherein the at least one processor is further configured to execute the computer-readable instructions to:
select one or more cryptocurrency exchanges from among the plurality of cryptocurrency exchanges; and
determine the market price based on at least one of an average price, a minimum price, and a maximum price of the cryptocurrency in the cryptocurrency market, based on price information of the cryptocurrency on the selected one or more cryptocurrency exchanges.

18. The computer system of claim 15, wherein the at least one processor is further configured to execute the computer-readable instructions to:
trigger the circuit breaker based on the trading price being out of a predetermined range of the market price.

19. The computer system of claim 18, wherein the at least one processor is further configured to execute the computer-readable instructions to sequentially trigger a plurality of circuit breaker modes having different triggering criterion, based on a number of times that the trading price is out of the predetermined range of the market price being greater than a predetermined number of times.

20. The computer system of claim 18, wherein
the at least one processor is further configured to execute the computer-readable instructions to:
select a single circuit breaker mode from among a plurality of circuit breaker modes having different triggering criterion, based on a difference between the trading price of the cryptocurrency on the first cryptocurrency exchange and the market price, and
trigger the circuit breaker based on the selected circuit breaker mode.
